(19) United States
(12) Patent Application Publication
(10) Pub. No.: US 2004/0203618 A1
(43) Pub. Date: Oct. 14, 2004

(54) Convenient messaging from a wireless terminal

(76) Inventors: Stephen K. Lau, Marlboro, NJ (US); Winston Hong Lieu, Holmdel, NJ (US)

Correspondence Address: DEMONT & BREYER, LLC, SUITE 250, 100 COMMONS WAY, HOLMDEL, NJ, 07733, US

(21) Appl. No.: 10/243,226

(22) Filed: Sep. 13, 2002

(51) Int. Cl. H04M 11/10; H04Q 7/20

(52) U.S. Cl. 455/412.1; 455/466

(57) ABSTRACT

A technique is disclosed for more conveniently creating a message at a wireless terminal and sending the message to a user-specified group of one or more recipients. The illustrative embodiment of the present invention, for the purposes of creating and sending a message, essentially rearranges the conventional wireless communication paradigm. The conventional paradigm consists of first specifying a destination address (e.g., dialed digits of the called party, etc.), then hitting the “SEND” key, and then communicating. Instead, the illustrative embodiment specifies first communicating (i.e., creating a message), then specifying one or more destination addresses, and then hitting the “SEND” key. This is beneficial in that this new paradigm takes into account the notion that communication, particularly communication from a wireless terminal, is often impulsive, and that email, or other user-defined messaging, when conducted on a wireless terminal, should conform to this notion to be most effective and convenient.

### FIELD OF THE INVENTION

The present invention relates to wireless telecommunications in general, and, more particularly, to the design of a wireless terminal that creates and sends user-specified messages.

### BACKGROUND OF THE INVENTION

The popularity of wireless telecommunications (e.g., cellular telephones, cordless telephones, wireless local area networks, etc.) has created the demand for wireless terminals that are increasingly user-friendly and that minimize keypad use in preparing user messages that originate from wireless terminals.

In particular, a user-specified message such as email is often difficult to create and send from a wireless terminal, especially when the user is distracted by something else (e.g., riding in a vehicle, etc.). Typically, the user has to key in the address or addresses of one or more recipients of the email, enter the main text of the email, possibly add an attachment file, and then indicate to the wireless terminal to transmit the message. Entering text can be especially cumbersome since the keypad of a wireless terminal is typically not well-suited to text entry.

A need exists for a more streamlined and convenient technique for creating and sending a user-specified message from a wireless terminal.

### SUMMARY OF THE INVENTION

The present invention is a wireless terminal that avoids some of the costs and disadvantages in the prior art. In particular, the illustrative embodiment of the present invention incorporates a technique for more conveniently creating a message at a wireless terminal and sending the message to a user-specified group of one or more recipients.

The illustrative embodiment of the present invention, for the purposes of creating and sending a message, essentially rearranges the conventional wireless communication paradigm. The conventional paradigm consists of first specifying a destination address (e.g., dialed digits of the called party, etc.), then hitting the “SEND” key, and then communicating. Instead, the illustrative embodiment specifies first communicating (i.e., creating a message), then specifying one or more destination addresses, and then hitting the “SEND” key. This is beneficial in that this new paradigm takes into account the notion that communication, particularly communication from a wireless terminal, is often impulsive, and that email, or other user-defined messaging, when conducted on a wireless terminal, should conform to this notion to be most effective and convenient. By having the user specify the message first, the part of email creation requiring the most concentration is accomplished when the user is focused and ready.

The illustrative embodiment specifies, in one mode, the wireless terminal accepting a voice message from the user, in place of a text message. The user records a voice message into the wireless terminal, specifies one or more addresses, and then transmits the message. In the prior art, the voice message was typically treated from the user's perspective as an attachment to an email that included a main body (i.e., of text). In the illustrative embodiment, the voice message, or any other media form for that matter, is the message, dispensing with the notion of an email body and attachment. The creation and transmission of the message is more convenient, because the user is left to record something that involves little more effort than speaking into the phone and making a limited number of keystrokes. The keystrokes can be made using existing keys on the wireless terminal (e.g., “SEND” key, etc.), or the keystrokes can involve a dedicated set of keys.

The rearranged ordering of message creation and transmission also lends itself to exchanging files stored within the wireless terminal. For instance, the user can choose to exchange his or her favorite ringing tone or welcome display image, already stored in an electronic file in the wireless terminal.

The illustrative embodiment of the present invention comprises: recording a message; saving the message to an electronic file; associating the electronic file with at least one destination address wherein associating is performed after recording of the message; and transmitting the electronic file to the at least one destination address.

### BRIEF DESCRIPTION OF THE DRAWINGS

FIG. 1 depicts a block diagram of the salient components of wireless terminal 100 in accordance with the illustrative embodiment of the present invention.

FIG. 2 depicts a flowchart of the tasks related to the first illustrative embodiment of the present invention.

FIG. 3 depicts a flowchart of the tasks related to the second illustrative embodiment of the present invention.

### DETAILED DESCRIPTION

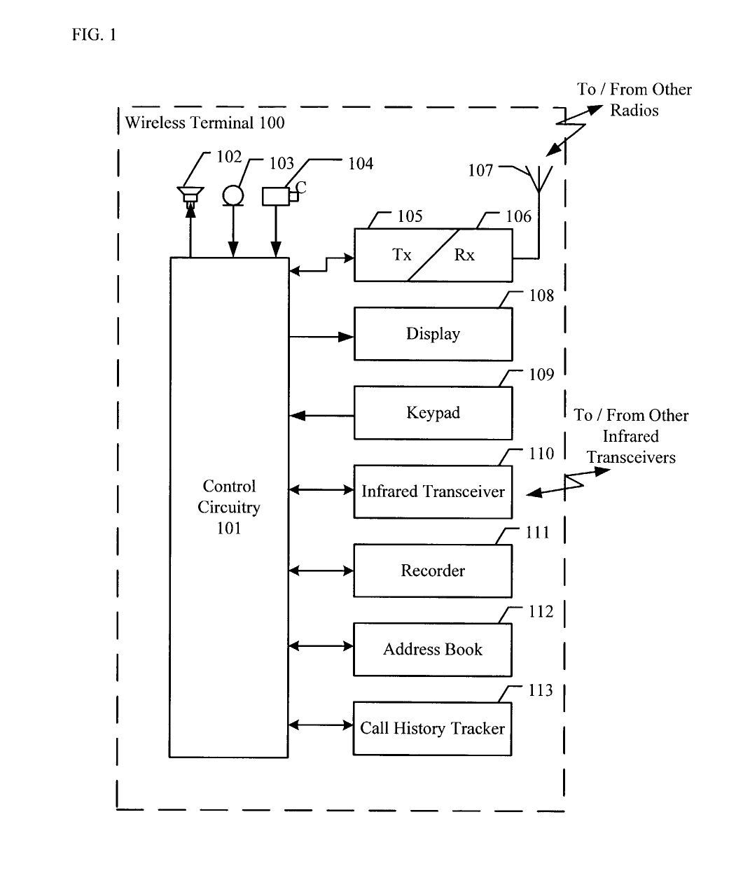

FIG. 1 depicts a block diagram of the salient components of wireless terminal 100 in accordance with the illustrative embodiment of the present invention. Wireless terminal 100 provides wireless telecommunications capability and is, therefore, capable of transmitting and receiving both voice and data with wireless base stations (not shown) or other wireless terminals or both.

Wireless terminal 100 advantageously comprises: control circuitry 101, speaker 102, microphone 103, video capture device 104, transmitter 105, receiver 106, antenna 107, visual display 108, keypad 109, infrared transceiver 110, recording device and memory 111, address book 112, and call history tracker 113.

Transmitter 105, receiver 106, and antenna 107 provide wireless telecommunications capability to wireless terminal 101 at radio frequencies. Embodiments of the present invention can use any access technology (e.g., frequency division multiple access, time-division multiple access, time-division duplex, code-division multiple access, etc.) and any modulation scheme (e.g., frequency shift keying, quadrature phase-shift keying, etc.) in accordance with any interface (e.g., ANSI-136, IS-95, GSM, Bluetooth, 802.11, etc.). Furthermore, wireless terminal 100 can transmit and receive at any frequency (e.g., 800 MHz, 1800 MHz, etc.). It will be clear to those skilled in the art how to make and use transmitter 105, receiver 106, and antenna 107.

Display 108 is a visual display that enables wireless terminal 100 to output information (e.g., text, images, video, etc.) to a user of wireless terminal 100. It will be clear to those skilled in the art how to make and use display 108.

Infrared transceiver 110 is a device (e.g., an IrDA compliant device, etc.) that enables wireless terminal 100 to communicate with other devices via the modulation of infrared light. It will be clear to those skilled in the art how to make and use infrared transceiver 110.

Recorder 111 is a device that enables wireless terminal 100 to record information (e.g., audio, video, images, text, etc.) from a user of wireless terminal 100. Recorder 111 also enables encoding of the recorded information to a format suitable for saving to a memory within wireless terminal 100. Recorder 111 saves the information in the form of an electronic file to a memory for later retrieval and, in doing so, serves as a storage mechanism. It will be clear to those skilled in the art how to make and use recorder 111.

Address book 112 is a device that enables wireless terminal 100 to store address information (e.g., names, indices to audio segments for voice recognition purposes, speed dial tags, telephone numbers, email addresses, pager information, etc.) by a user of wireless terminal 100. The address information is stored in memory for later retrieval. It will be clear to those skilled in the art how to make and use address book 112.

Call history tracker 113 is a device that enables wireless terminal 100 to store information on calls either made to or originating from wireless terminal 100. One example of storable call history information is a record of the N most recent calls, wherein N is a positive integer. One subset of the N most recent calls is the “last call” (i.e., single most recent call) information. The call history tracker can track calls originated from the wireless terminal, calls made to the wireless terminal, or calls missed, or some combination of the three. It will be clear to those skilled in the art how to make and use call history tracker 113. It will also be clear to those skilled in the art how to determine the value for N when used.

Keypad 109 is a tactile input device that enables wireless terminal 100 to receive information from a user of wireless terminal 100. Keypad 109 is capable of conveying the information to control circuitry 101 for use as described in detail below. Examples of information from the user include text entry, address selection, dialing of digits, initiating a call, and ending a call. It will be clear to those skilled in the art how to make and use keypad 109.

Microphone 103 is capable of receiving an acoustic signal (e.g., the speech of the user of wireless terminal 100, etc.) and of conveying that information to control circuitry 101 for use as described in detail below. It will be clear to those skilled in the art how to make and use microphone 103.

Video capture device 104 is capable of receiving a picture signal (e.g., full motion video, still image, etc.) and of conveying that information to control circuitry 101 for use as described in detail below. Video capture device 104 can be a built-in device converting pictures to electrical signals (e.g., a camera., etc.), or it can be an interface (e.g., Firewire, USB, etc.) to an external device. It will be clear to those skilled in the art how to make and use video capture device 104.

Speaker 102 is capable of outputting an acoustic signal (e.g., the speech of another person, an alerting or ringing signal, etc.) to a user of wireless terminal 101 in well-known fashion. It will be clear to those skilled in the art how to make and use speaker 102.

Control circuitry 101 is capable of coordinating and controlling the other components of wireless terminal 100 so that wireless terminal 100 provides wireless telecommunications capability. In support of messaging, control circuitry 101 serves as a control mechanism for associating electronic files with destination addresses. Control circuitry 101 can comprise special-purpose hardware or programmed general-purpose hardware or both.

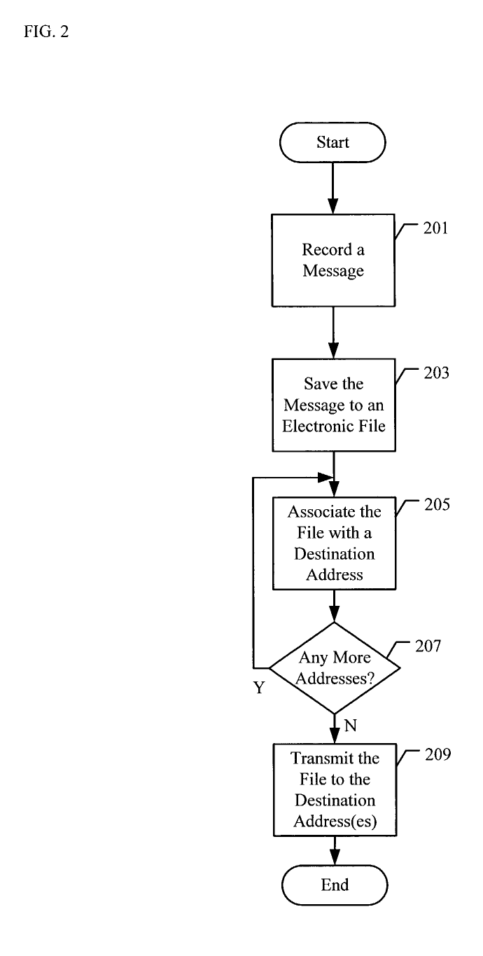

FIG. 2 depicts a flowchart of the tasks performed in the first illustrative embodiment of the present invention. Referring to FIG. 2, control circuitry 101 at task 201 recognizes an indication from the user, such as from keypad 109, to start recording a message from the user of wireless terminal 100. Control circuitry 101 prompts the user to start recording a message into microphone 103. In a second mode of operation, control circuitry 101 prompts the user to capture a video image or video segment using video capture device 104. In a third mode of operation, control circuitry 101 prompts the user to enter a text message using keypad 109. The user prompt can be a tone played through speaker 102, a visual indication displayed on display 108, or both. Control circuitry 101 commands recorder 111 to accept message input from the user.

At task 203, control circuitry 101 recognizes an indication from the user, such as from keypad 109, to end recording of the message from the user of wireless terminal 100. Control circuitry 101 acknowledges to the user the end of the recording through a prompt, which can be a tone played through speaker 102, a visual indication displayed on display 108, or both. Control circuitry 101 commands recorder 111 to stop recording of the user message. Recorder 111 then saves the user message to an electronic file.

At task 205, control circuitry 101 associates the electronic file saved by recorder 111 with one or more destination addresses of intended recipients. The destination addresses can be keyed in by the user of wireless terminal 100 by using keypad 109, which, in turn, can be stored into address book 112. In a second mode of operation, the destination addresses is derived from the user speaking a name or some other identifier into microphone 103, which, in turn, is mapped to a pre-stored destination address in address book 112. In a third mode of operation, the destination address is identified by the user keying in an identifier associated with an intended recipient (e.g., a speed dial number), which, in turn, is mapped to a pre-stored destination address in address book 112. In a fourth mode of operation, the destination address is identified by selecting from a list of calls maintained in call history tracker 113. If a pre-stored destination address exists for the selected recipient, it is retrieved from address book 112. If it does not exist, the user can be prompted to enter the destination address, which, in turn, can be stored into address book 112.

At task 207, control circuitry 101 prompts the user for additional destination addresses, if there are any. If the user wishes to enter an additional destination address, then control circuitry 101 repeats the tasks in task 205. Otherwise, control proceeds to task 209.

At task 209, control circuitry 101 retrieves the electronic file from recorder 111, along with the specified destination addresses. Control circuitry 101 determines how the message is to be routed. As one example, control circuitry 101 can choose to route the message in email format and protocol. As another example, control circuitry 101 can choose to route the message in short message service (SMS) format and protocol. It will be clear to those skilled in the art how to build a message in email format and protocol, SMS format and protocol, or another format and protocol. Control circuitry 101 then commands transmitter 105 to transmit the message. Alternatively, control circuitry 101 commands infrared transceiver 110 to transmit the message.

The number of keystrokes that that the user makes and the number of keys that are used can be optimized. For instance, in one mode of the illustrative embodiment of the present invention, the user can use the same key to initiate the recording of the message, the association of the recording with the destination address or addresses, and the transmitting of the message. This key can be a dedicated key (i.e., for messaging purposes only), or it can be the same key that performs the “SEND” function that is used to initiate a call from the wireless terminal. It will be clear to those skilled in the art how to make and use one or more keys to accomplish the tasks described.

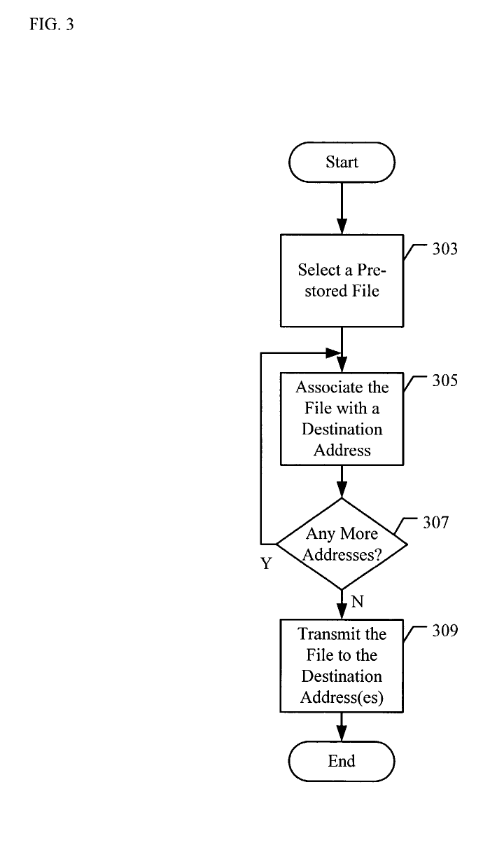

FIG. 3 depicts a flowchart of the tasks performed in the second illustrative embodiment of the present invention. Referring to FIG. 3, control circuitry 101 at task 303 recognizes an indication from the user, such as from keypad 109, to select a pre-stored file that is identified by the user of wireless terminal 100. As one example, the file can represent a particular ringing or alerting tone that the user wants to send to a recipient. As another example, the file can represent a displayable image, such as an icon on a wireless terminal display, a welcome screen on the display, or some other display screen object that the user would like to provide to others. The pre-stored file can be other files stored within the wireless terminal. It will be clear to those skilled in the art bow to access a pre-stored file. The prompt can be a tone played through speaker 102, a visual indication displayed on display 108, or both.

At task 305, control circuitry 101 associates the pre-stored file with one or more destination addresses of intended recipients. The destination addresses can be keyed in by the user of wireless terminal 100 by using keypad 109, which, in turn, can be stored into address book 112. In a second mode, the destination addresses can be derived from the user speaking a name or some other identifier into microphone 103, which, in turn, is mapped to a pre-stored destination address in address book 112. In a third mode, the destination address is identified by keying in an identifier associated with an intended recipient (e.g., a speed dial number), which, in turn, is mapped to a pre-stored destination address in address book 112. In a fourth mode, the destination address is identified by selecting from a list calls maintained in call history tracker 113. If a pre-stored destination address exists for the selected recipient, it is retrieved from address book 112. If it does not exist, the user can be prompted to enter the destination address, which, in turn, can be stored into address book 112.

At task 307, control circuitry 101 prompts the user for additional destination addresses, if there are any. If the user wishes to enter an additional destination address, then control circuitry 101 repeats the tasks in task 305. Otherwise, control proceeds to task 309.

At task 309, control circuitry 101 retrieves the pre-stored file from recorder 111, along with the specified destination addresses. Control circuitry 101 determines how the message is to be routed. In one example, control circuitry 101 can choose to route the message in email format and protocol. In another example, control circuitry 101 can choose to route the message in short message service (SMS) format and protocol. It will be clear to those skilled in the art how to build a message in email format and protocol, SMS format and protocol, or another suitable format and protocol. Control circuitry 101 then commands transmitter 105 to transmit the message. Alternatively, control circuitry 101 commands infrared transceiver 110 to transmit the message.

The number of keystrokes that that the user makes and the number of keys that are used can be optimized. For instance, in one mode of the illustrative embodiment of the present invention, the user can use the same key to initiate selecting the pre-stored file, the association of the file with the destination address or addresses, and the transmitting of the file. This key can be a dedicated key (i.e., for messaging purposes only), or it can be the same key that performs the “SEND” function that is used to initiate a call from the wireless terminal. It will be clear to those skilled in the art how to make and use one or more keys to accomplish the tasks described.

It is to be understood that the above-described embodiments are merely illustrative of the invention and that many variations may be devised by those skilled in the art without departing from the scope of the invention. It is therefore intended that such variations be included within the scope of the following claims and their equivalents.

What is claimed is:

1. A method for creating and sending a message from a wireless terminal, said method comprising:
recording a message;
saving said message into an electronic file;
associating said electronic file with at least one destination address wherein said associating is performed after said recording of said message; and
transmitting said electronic file to said at least one destination address.

2. The method of claim 1 wherein said recording of said message is initiated by actuating a first key, said associating of said electronic file with said at least one destination address is initiated by actuating said first key, and said transmitting of said electronic file is initiated by actuating said first key.

3. The method of claim 2 further wherein said first key is also used to initiate a call that is originated from said wireless terminal.

4. The method of claim 1 wherein said electronic file is transmitted in email format and protocol.

5. The method of claim 1 wherein said electronic file comprises audio information.

6. The method of claim 1 wherein said electronic file comprises at least one of text information, video information, and image information.

7. The method of claim 1 wherein said at least one destination address is selected from a record of the N most recent calls wherein N is a positive integer.

8. The method of claim 1 wherein said at least one destination address is derived from at least one spoken phrase.

9. A wireless terminal comprising:
a recorder for recording a message;
a storage mechanism for saving said message into an electronic file;
a control mechanism for associating said electronic file with at least one destination address wherein said control mechanism associates said electronic file with said at least one destination address after said recording of said message; and
a transmitter for transmitting said electronic file to said at least one destination address.

10. The wireless terminal of claim 9 further comprising a first key for initiating said recording of said message, for initiating said associating of said electronic file with said at least one destination address, and for initiating said transmitting of said electronic file.

11. The wireless terminal of claim 10 wherein said first key is also used to initiate a call that is originated from said wireless terminal.

12. The wireless terminal of claim 9 wherein said wireless terminal transmits said electronic file in email format and protocol.

13. The wireless terminal of claim 9 wherein said electronic file comprises at least one of audio information, video information, image information, and text information.

14. The wireless terminal of claim 9 wherein said at least one destination address is selected from a record of the N most recent calls wherein N is a positive integer.

15. The wireless terminal of claim 9 wherein said at least one destination address is derived from at least one spoken phrase.

16. A method for specifying and sending a message from a wireless terminal, said method comprising:
selecting a pre-stored file;
associating said pre-stored file with at least one destination address wherein said associating is performed after said recording of said message; and
transmitting said pre-stored file to said at least one destination address.

17. The method of claim 16 wherein said pre-stored file represents a ringing tone.

18. The method of claim 16 wherein said pre-stored file represents an image.

19. The method of claim 16 wherein said selecting of said pre-stored file is initiated by actuating a first key, said associating of said pre-stored file with said at least one destination address is initiated by actuating said first key, and said transmitting of said pre-stored file is initiated by actuating said first key.

20. The method of claim 19 further wherein said first key is also used to initiate a call that is originated from said wireless terminal.

21. The method of claim 16 wherein said pre-stored file is transmitted in email format and protocol.

22. The method of claim 16 wherein said at least one destination address is selected from a record of the N most recent calls wherein N is a positive integer.
